(19) United States
(12) Patent Application Publication
(10) Pub. No.: US 2001/0011369 A1
(43) Pub. Date: Aug. 2, 2001

(54) OBJECT TIME PROGRAM TRANSLATION SYSTEM

(76) Inventors: MOTOAKI SATOYAMA, SAGAMIHARA-SHI (JP); YUKIAKI NOMURA, YOKOHAMA-SHI (JP)

Correspondence Address: FAY SHARPE BEALL FAGAN, MINNICH & MCKEE, 104 EAST HUME AVENUE, ALEXANDRIA, VA, 22301

(21) Appl. No.: 09/030,280

(22) Filed: Feb. 25, 1998

(30) Foreign Application Priority Data
Feb. 28, 1997 (JP) 09-045688

(51) Int. Cl. G06F 9/44

(52) U.S. Cl. 717/4

(57) ABSTRACT

An intermediate language data interpretation program 123 generates execution frequency data 126 by counting the number of times each of the modules of a source program or an intermediate language program is executed during interpretation. In parallel with execution of the program, an object time translation program 124 selects from the execution frequency data 126 the module currently having the highest execution frequency, and translates the selected module preferentially into a machine language program.

### FIELD OF THE INVENTION

The present invention relates to an object time program translation system. More particularly, the invention relates to an object time program translation system which, in a network environment connecting a server computer to a plurality of client computers of different types, reads from the server computer an intermediate language program commonly executable by a plurality of computers. Furthermore, while using interpretation means such as an interpreter to interpret the intermediate language program thus read, the program is translated into a machine language program specific to a client computer.

### BACKGROUND OF THE INVENTION

One conventional method for translating, into a machine language program, an intermediate language program common to a plurality of computers of different types in a computer system is disclosed illustratively in Japanese Patent Laid-Open No. Hei 4-322329. Conventional techniques associated with intermediate language programs and with object time program translation systems are discussed illustratively in “C Magazine”, Vol. 8, No. 5, pp. 22-61 (May 1996, Soft Bank, in Japanese).

### SUMMARY OF THE INVENTION

The conventional object time program translation method cited above translates a read-in intermediate language program in all of its modules including those not executed in practice. The method thus requires an inordinately long time for program translation. Because an object program cannot be executed until the translation is finished, it takes a long time to start the program.

One way to bypass such deficiencies of the conventional object time program translation method has been proposed according to an object time program translation method that translates an intermediate language program into a machine language program every time a module of the intermediate language program is executed for the first time. This way, any modules that are executed only once are also translated into the machine language program. One problem with this method is that modules that are executed once or a few times at most have their translation time combined with the execution time of their machine language programs, which amounts to a sum longer than the time required directly to interpret the intermediate language program by interpretation means such as an interpreter.

Another problem with the above-mentioned object time program translation method is that it requires a large memory for program execution. This large memory is needed to accommodate machine language programs that are greater in storage size than intermediate language programs. A computer that has a limited memory size cannot translate all intermediate language programs into machine language programs without exhausting its memory capacity. The method is thus not applicable to computers with small memories.

It is therefore a first object of the present invention to overcome the above-mentioned and other deficiencies and disadvantages of the prior art and to provide an object time program translation system which, while interpreting a source program or an intermediate language program, carries out translation into a machine language program effectively so as to improve the processing efficiency of the computer to which the system is applied.

It is a second object of the present invention to provide an object time program translation system which, while interpreting a source program or an intermediate language program, generates execution frequency data by counting the number of times each of the modules making up the program is executed, so that the module with the highest execution frequency selected from the execution frequency data is translated into a machine language program concurrently with the interpretation.

It is a third object of the present invention to provide an object time program translation system which does not translate into a machine language program the program modules whose execution frequency data are below a predetermined threshold value.

It is a fourth object of the present invention to provide an object time program translation system which can display progress status of translation into a machine language program and which may stop the translation into a machine language program prior to completion, such as when the translation is halfway completed.

The first and the second objects may be achieved according to one aspect of the present invention, which provides an object time program translation system for interpreting either a source program or an intermediate language program common to a plurality of computers and for translating the program into a machine language program specific to any one of the computers. The object time program translation system includes: interpretation means for interpreting either the source program or the intermediate language program; and program translation means for translating either the source program or the intermediate language program into a machine language program in units of modules; wherein the interpretation means generates execution frequency data by counting the number of times each of the modules is executed while either the source program or the intermediate language program is being interpreted; and wherein, concurrently with the interpretation of either the source program or the intermediate language program by the interpretation means, the program translation means selects from the execution frequency data the module that has been executed most frequently and translates the module in question into a machine language program.

The third object may be achieved according to a preferred embodiment of the invention, which provides an object time program translation system wherein the interpretation means does not translate into a machine language program the modules about which the execution frequency data are below a predetermined threshold value.

The fourth object may be achieved according to another preferred embodiment of the invention, which provides an object time program translation system further including translation progress status display means for displaying progress status of translation into a machine language program, and wherein the translation into a machine language program may be stopped prior to completion, such as when the translation is halfway completed.

According to the invention as outlined above, the execution frequency data about the program modules are obtained and, at the same time, frequently executed program modules are selected from the execution frequency data and translated preferentially into machine language programs. In this manner, those machine language programs with high execution frequencies which were acquired through translation are executed efficiently by hardware, thereby improving system performance.

According to the invention, it is possible to determine whether or not any program modules are to be translated into a machine language program depending on their execution frequencies. This feature eliminates translation of unnecessary modules.

Also, according to the invention, all steps of the read-in source program or intermediate language program are recorded. Every time a program module is translated into a machine language program, the number of steps for the modules translated so far is divided by the total step count. The result of the division is displayed numerically on a screen, allowing the progress status of translation to be known. Another feature of the invention enables translation into a machine language program to be stopped at any point prior to completion, for example halfway.

These and other objects, features and advantages of the present invention will become more apparent in view of the following detailed description of the preferred embodiments in conjunction with the drawings.

### BRIEF DESCRIPTION OF THE DRAWINGS

FIG. 1 is a schematic block diagram of an apparatus for implementing an object time program translation system embodying the invention;

FIG. 2 is a schematic view of typical execution frequency data;

FIG. 3 is a schematic view of typical intermediate language data;

FIG. 4 is a schematic view of typical machine language data;

FIG. 5 is a flowchart of a start-up procedure of the basic control program in effect when the translation system embodying the invention is executed;

FIG. 6 is a flowchart of the intermediate language file read-in program;

FIG. 7 is a flowchart of the intermediate language data interpretation program;

FIG. 8 is a flowchart of the object time translation program;

FIG. 9 is a flowchart of the process of updating execution frequency data;

FIG. 10 is a flowchart of the process of translating intermediate language data; and

FIG. 11 is a schematic view of a typical screen display applicable to the process of displaying the progress status of translation.

### DETAILED DESCRIPTION OF THE PREFERRED EMBODIMENTS

An object time program translation system according to the preferred embodiments of the present invention will now be described in detail with reference to the accompanying drawings.

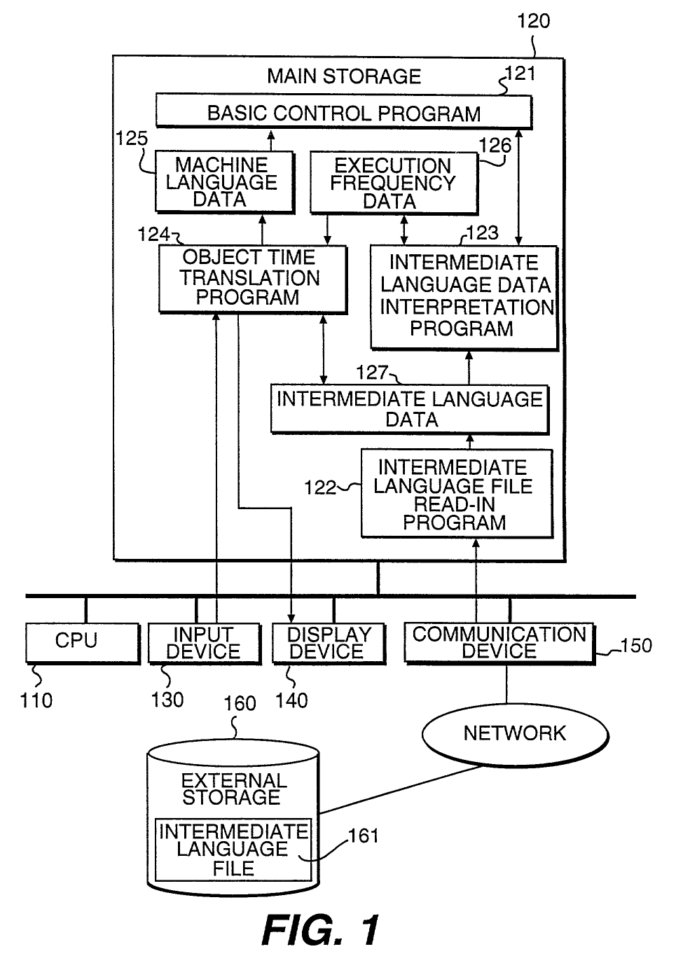

The apparatus shown in FIG. 1, includes CPU 110, main storage 120, basic control program 121, intermediate language file read-in program 122, intermediate language data interpretation program 123, object time translation program 124, machine language data 125, execution frequency data 126, intermediate language data 127, input device 130, display device 140, communication device 150, and external storage 160.

A bus arrangement interconnects the CPU 110, main storage 120, input device 130, such as a mouse and a keyboard, display device 140, and communication device 150 including a modem. The apparatus is connected to the external storage 160 such as a hard disk drive via communication device 150 and a network.

The main storage 120 is loaded with the basic control program 121, intermediate language file read-in program 122, intermediate language data interpretation program 123 and object time translation program 124. In addition, the main storage 120 accommodates the intermediate language data 127 generated by the intermediate language file read-in program 122, the execution frequency data 126 produced by the intermediate language data interpretation program 123, and the machine language data 125 prepared by the object time translation program 124. The external storage 160 contains the intermediate language file 161.

When the apparatus of FIG. 1 is started, an initial program loader furnished therein immediately loads the basic control program 121 either from the external storage 160 into the main storage 120 via the network, or from a built-in storage device such as a hard disk drive, not shown, into the main storage 120. Having been thus loaded, the basic control program 121 is run by the CPU 110 for basic control over the apparatus hardware and the programs.

The intermediate language file read-in program 122 is a program that reads the intermediate language file 161 from the external storage 160 via the communication device 150 and network. Using the file 161 thus read in, the program 122 generates the intermediate language data 127.

The intermediate language data interpretation program 123 constitutes intermediate language program execution means. The program 123 is illustratively made of an interpreter for interpreting the intermediate language data 127 for direct execution. At the same time, the intermediate language data interpretation program 123 generates the execution frequency data 126 by counting the number of times the intermediate language data 127 is executed in units of modules.

The object time translation program 124 is a program translation means. This is a program that selects from the execution frequency data 126 the intermediate language data module that has been most frequently executed and translates the selected module into machine language data 125. The machine language data 125 represents a program which, expressed in machine language, can be run directly by the CPU 110. The execution frequency data 126 denotes the number of times each of the intermediate language data modules interpreted by the intermediate language data interpretation program 123 has been executed.

The intermediate language data 127 is data prepared by the CPU 120 having read the intermediate language file 161. The data 127 is interpreted by the intermediate language data interpretation program 123 one instruction at a time. The intermediate language file 161 is a file that contains a program written by use of virtual instructions independent of any specific computer systems.

The intermediate language file read-in program 122, intermediate language data interpretation program 123 and object time translation program 124 are read by the basic control program 121 into the main storage 120 from the external storage 160 via the communication device 150 and network. The programs thus read are executed by the CPU 110.

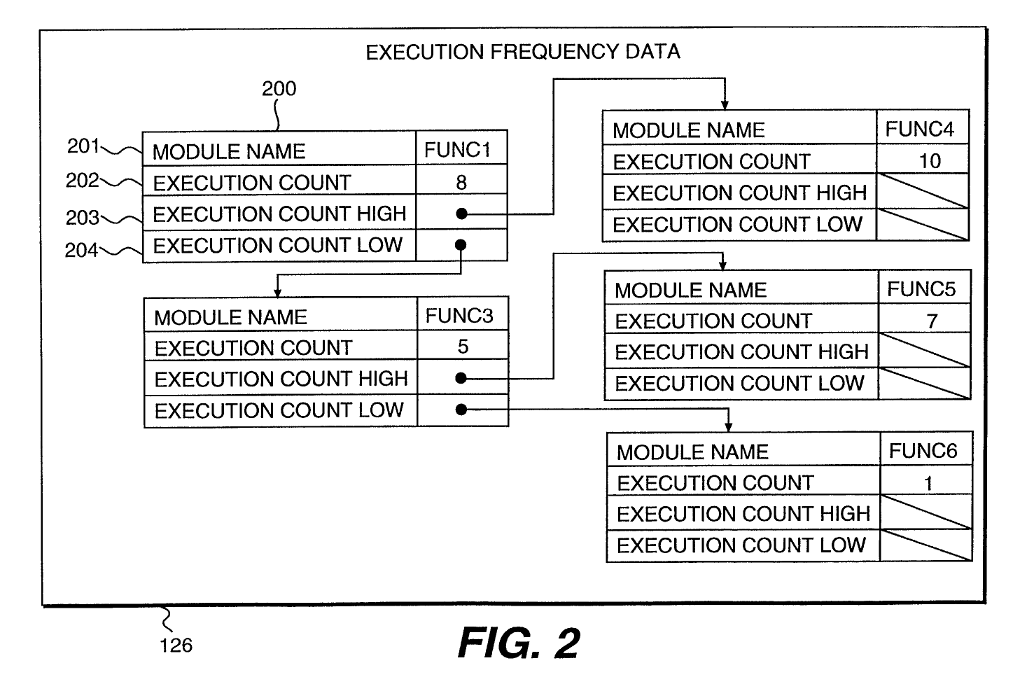

FIG. 2 is a schematic view of typical execution frequency data 126. In FIG. 2, reference numeral 200 indicates an execution frequency table corresponding to an intermediate language module 300. Each execution frequency table 200 has a module name field 201 with a module name representing the corresponding intermediate language module 300, an execution count 202 representing the number of times the intermediate language module 300 is executed, a pointer 203 pointing to the execution frequency table of an intermediate language module whose execution count is immediately higher than this count 202, and a pointer 204 pointing to the execution frequency table of an intermediate language module whose execution count is immediately lower than the count 202 of this table 200. The other execution frequency tables pointed to by the pointers are structured similarly. In other words, the execution frequency data 126 has a binary search tree structure connecting a plurality of execution frequency tables 200 by pointers.

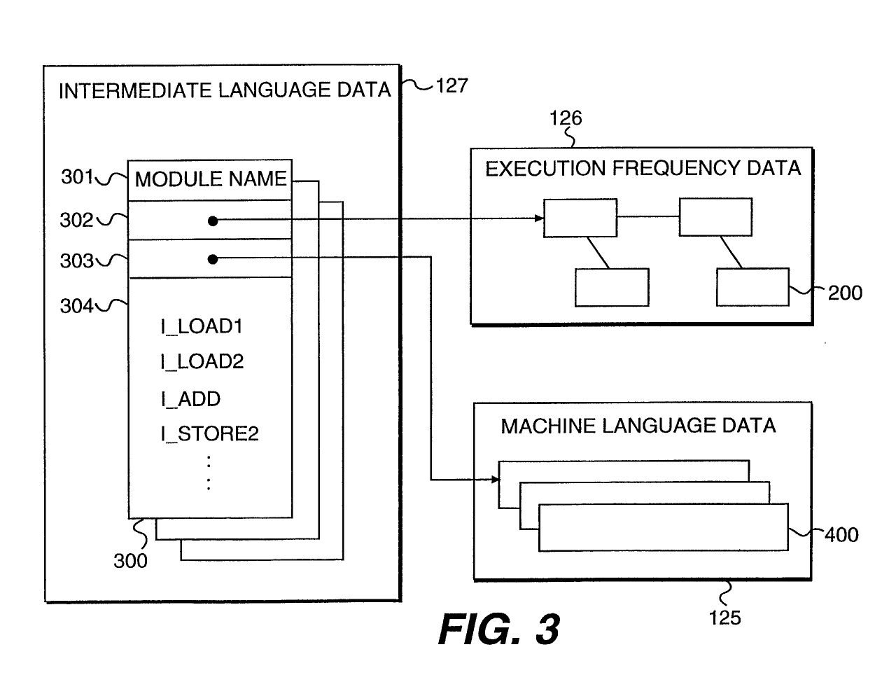

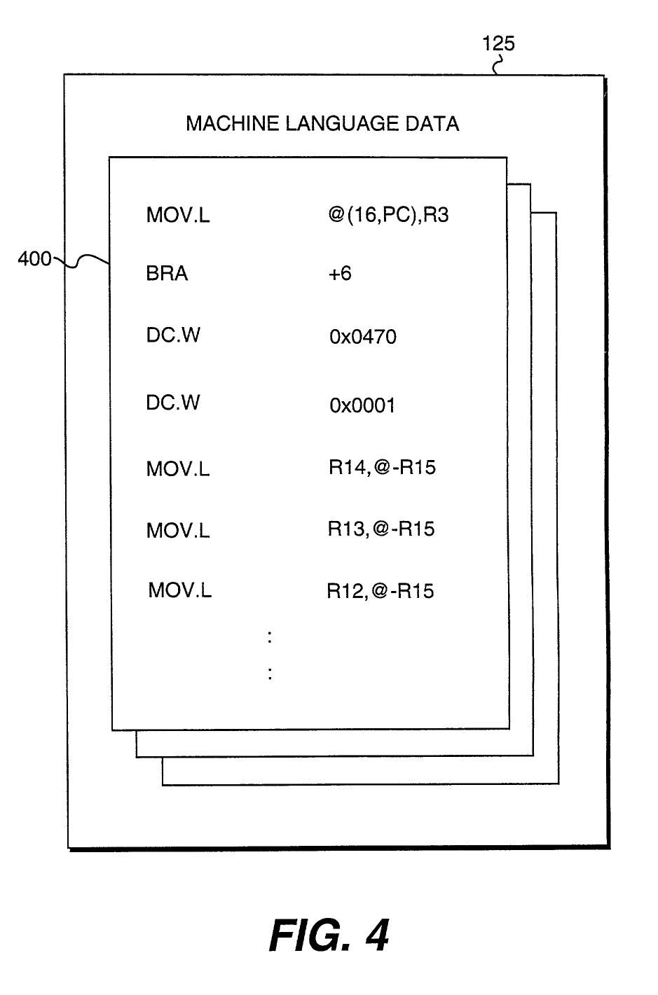

FIG. 3 is a schematic view of typical intermediate language data 127. In FIG. 3, reference numeral 300 indicates an intermediate language module that includes a module name field 301, pointers 302 and 303, and a data area 304. The module name field 301 contains a module name representing the intermediate language module 300 in question. The pointer 302 points to the execution frequency data 126 corresponding to the intermediate language module 300. The pointer 303 points to the machine language data 125, having a plurality machine language modules 400, obtained by translating the intermediate language module 300. The data area 304 accommodates a string of intermediate language program instructions constituting the intermediate language module 300. The intermediate language data 127 is composed of a plurality of intermediate language modules 300. The machine language data 125 is shown in more detail in FIG. 4. Here, machine language data 125 has modules 400 with a data area accommodating a plurality of machine language instructions.

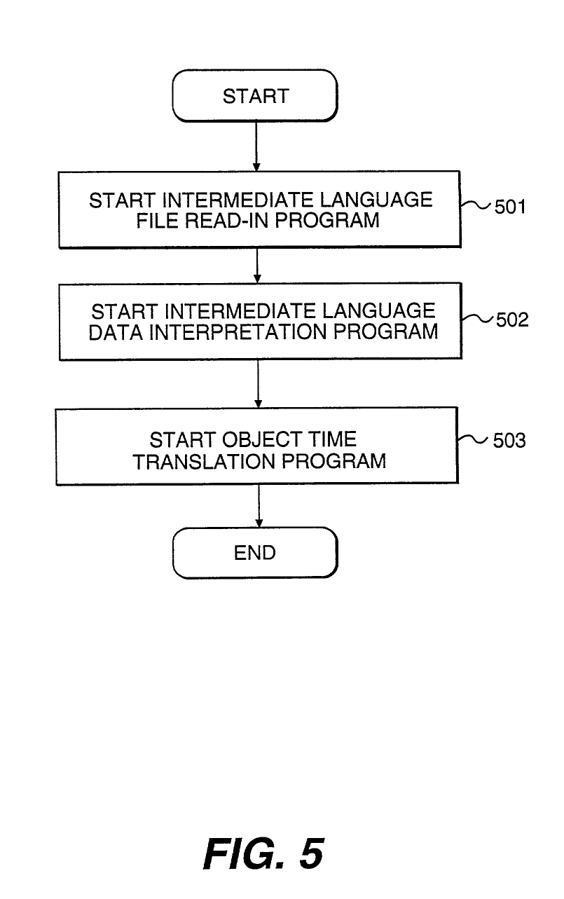

FIG. 5 is a flowchart of a start-up procedure of the basic control program 121 in effect when the translation system embodying the invention is executed. As shown in the flow of FIG. 5, the basic control program 121 first reads the intermediate language file 161, and then starts the intermediate language data interpretation program 123 and object time translation program 124. The intermediate language data interpretation program 123 and the object time translation program 124 are run in parallel.

(1) The basic control program 121 first starts the intermediate language file read-in program 122 and waits for the processing of the program 122 to terminate (step 501).

(2) With the processing of the intermediate language file read-in program 122 completed, the basic control program 121 starts the intermediate language data interpretation program 123 (step 502).

(3) The basic control program 121 then starts the object time translation program 124 (step 503).

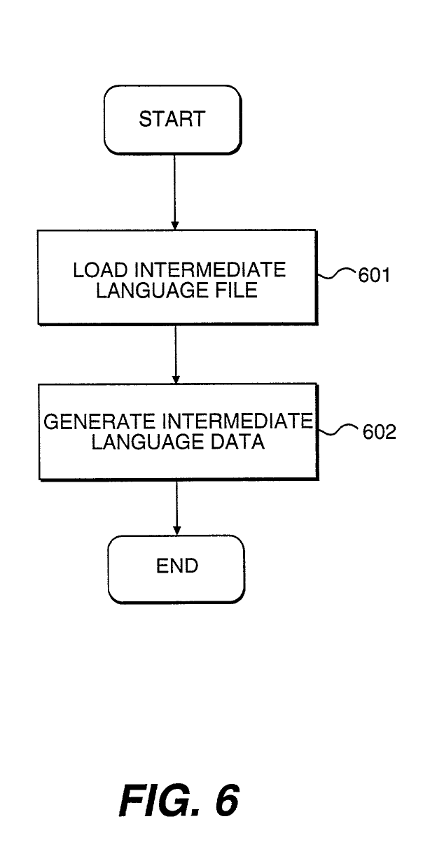

FIG. 6 is a flowchart of the intermediate language file read-in program 122. As shown in the flow of FIG. 6, the intermediate language file read-in program 122 reads the intermediate language file 161 and generates the intermediate language data 127 therefrom.

(1) The intermediate language file read-in program 122 is started in step 501 of FIG. 5 by the basic control program 121. After being started, the intermediate language file read-in program 122 reads the intermediate language file 161 from the external storage 160 via the communication device 150 and network (step 601).

(2) The intermediate language file read-in program 122 then generates the intermediate language data 127. The intermediate language data 127 thus generated includes a plurality of intermediate language modules 300 as shown in FIG. 3. The intermediate language file read-in program 122 places into the module name field 301 the module name of each module that has been read, initializes to “0” both the pointer 302 pointing to the execution frequency data 126 and the pointer 303 pointing to the machine language data 124, and writes to the intermediate language program data area 304 the intermediate language program contained in the intermediate language file that has been read (step 602).

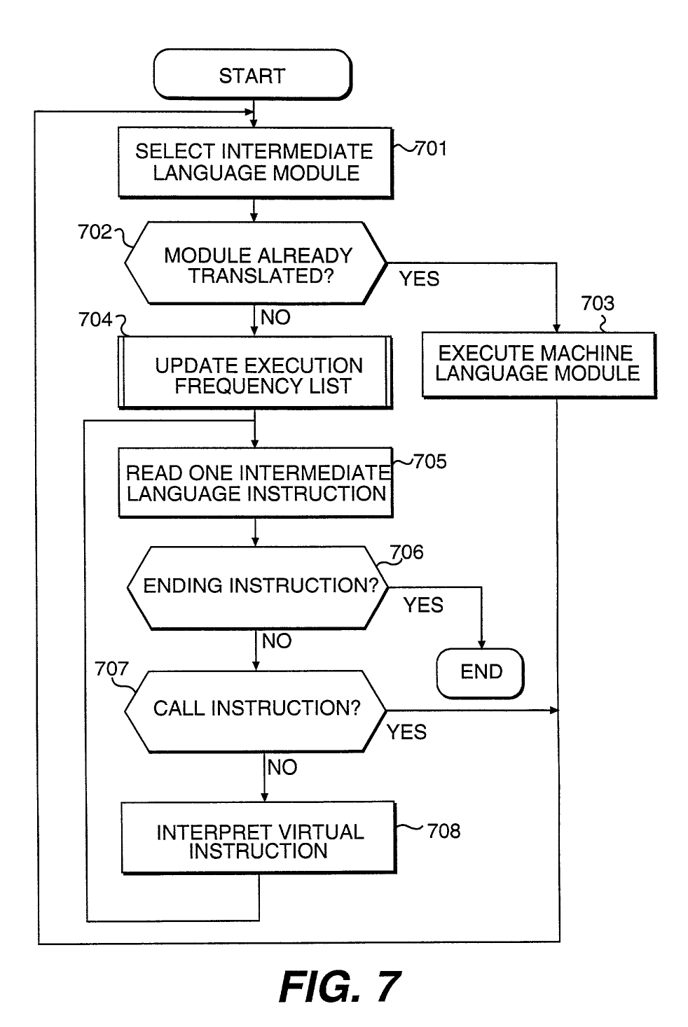

FIG. 7 is a flowchart of the intermediate language data interpretation program 123. As shown in the flow of FIG. 7, the intermediate language data interpretation program 123 repeats interpretation of the intermediate language data 127 and writes the execution count thus acquired to the execution frequency data 126.

(1) The intermediate language data interpretation program 123 is started in step 502 of FIG. 5 by the basic control program 121. After being started, the intermediate language data interpretation program 123 selects one intermediate language module 300 from the intermediate language data 127. In the initial state, the intermediate language module with “MAIN” set in the module name field 301 is selected (step 701).

(2) The intermediate language data interpretation program 123 then checks to see if the intermediate language module 300 selected in step 701 has already been translated into a machine language program. If the selected intermediate language module 300 is found to have been translated already, the intermediate language data interpretation program 123 causes the basic control program 121 to execute the machine language program contained in the machine language module 400 pointed to by the pointer 303 held in the selected module 300. With the machine language program executed, step 701 is reached again (steps 702 and 703).

(3) If the check in step 702 reveals that the intermediate language module 300 has yet to be translated into a machine language program, the intermediate language data interpretation program 123 updates the execution frequency table included in the intermediate language module 300 selected in step 701 (step 704).

(4) The intermediate language data interpretation program 123 reads one instruction from inside the intermediate language program 304 contained in the intermediate language module 300 selected in step 701. If the instruction turns out to be an ending instruction, the processing is terminated (steps 705 and 706).

(5) If the read-in instruction checked in step 706 is not an ending instruction, the intermediate language data interpretation program 123 checks to see if the instruction read in step 705 is a call instruction. If the instruction turns out to be a call instruction, the processing is terminated. Otherwise the instruction read in step 705 is directly executed, and step 705 is reached again for the processing of the next instruction (steps 707 and 708).

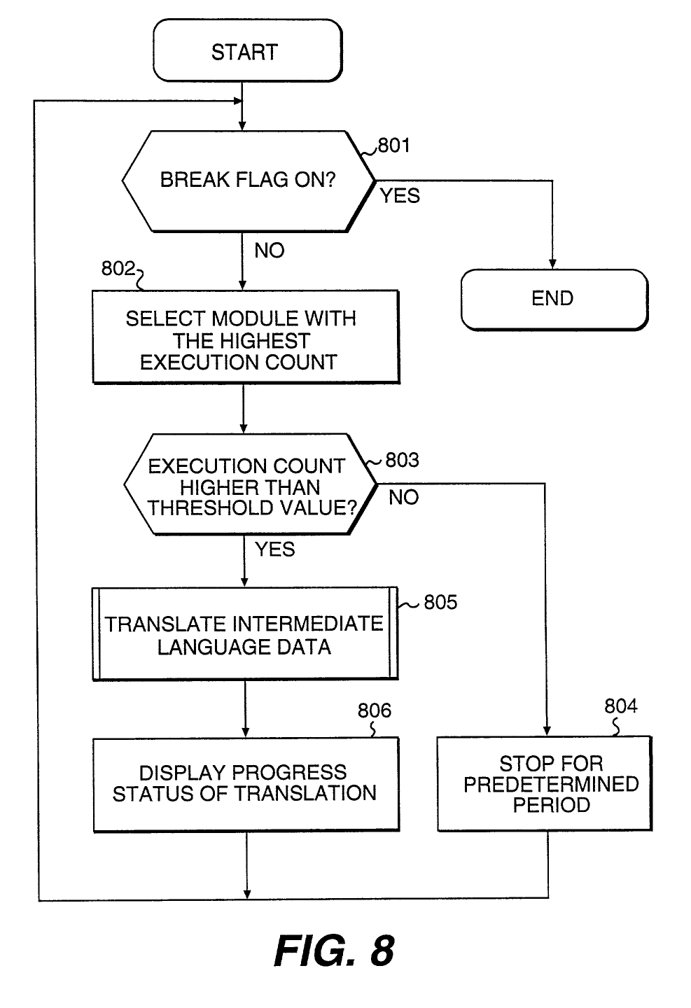

FIG. 8 is a flowchart of the object time translation program 124. As shown in the flow of FIG. 8, the object time translation program 124 selects from the execution frequency data 126 the execution frequency table 200 whose execution count 202 is the highest. If the execution count 202 is found to be higher than a predetermined threshold value, the object time translation program 124 translates into a machine language program the intermediate language program 304 of the intermediate language module 300 having the same name as the module name 201 contained in the selected execution frequency table 200. The object time translation program 124 repeats the process of placing the machine language program into the machine language module pointed to by the pointer 303 in the module 300, until a break flag is turned on.

(1) The object time translation program 124 is started in step 503 of FIG. 5 by the basic control program 121. After being started, the object time translation program 124 checks to see if the break flag, not shown in FIG. 1, is turned on. If the flag is found to be on, the processing is stopped. The break flag is turned on when a translation break button 1101 is selected on the input device 130 (step 801).

(2) If the break flag is found to be off in step 801, the object time translation program 124 selects from the execution frequency data 126 the execution frequency table 200 having the highest execution count 202. A check is then made to see if the execution count 202 included in the selected execution frequency table 200 is higher than the predetermined threshold value (steps 802 and 803).

(3) If the execution count 202 is found to be lower than the predetermined threshold value in step 803, the object time translation program 124 stops the translation process for a predetermined period of time, and step 801 is reached again. If the execution count 202 is found to be higher than the threshold value, the translation program 124 translates the intermediate language data into machine language data using as an argument the intermediate language module 300 having the same name as the module name 201 contained in the execution frequency table 200 selected in step 802 (steps 804 and 805).

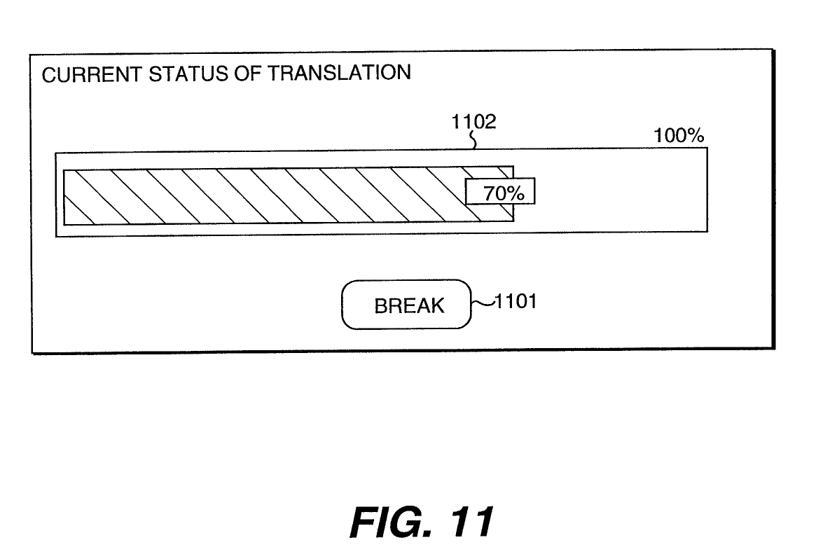

(4) The object time translation program 124 then calculates how many of the intermediate language modules 300 in the intermediate language data have been translated into machine language programs, prepares in percentage points the calculated progress status of translation for display, and causes the display device 140 to display the progress status, as shown in FIG. 11 (step 806). Then step 801 is reached again.

As described above, when the execution count of a module is lower than the predetermined threshold value, that module is not translated into machine language data. This makes it possible to efficiently translate intermediate language modules into machine language data. After the apparatus employing the present invention has started processing intermediate language data, the object time translation program 124 will not start its processing unless and until the execution count for a given module reaches the predetermined threshold value.

In the flowchart of FIG. 8, arrangements may be made to remove steps 803 and 804. This is done as follow. After the apparatus has started processing intermediate language data, the intermediate language data interpretation program 123 executes the first module. This sets to “1” the execution count of the execution frequency table corresponding to the first module executed. Translation using the object time translation program 124 starts with this module because it currently has the highest execution count. If the intermediate language data interpretation program 123 executes a plurality of modules by the time the translation of the first module has ended, the execution frequency tables will have been updated during module execution. Such execution frequency table updates allow the object time translation program 124 to keep selecting the most frequently executed module for continuous translation.

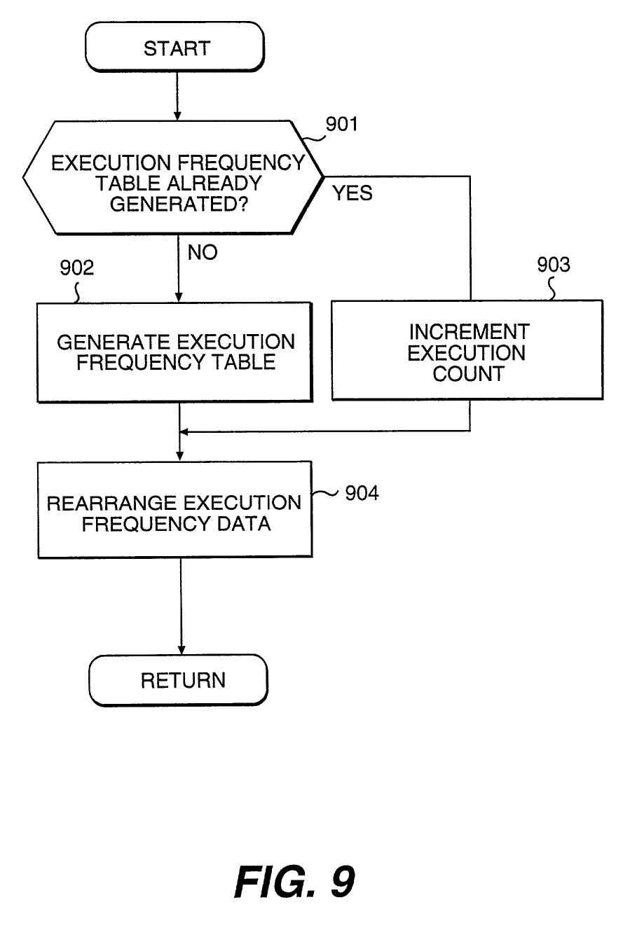

FIG. 9 is a flowchart detailing how step 704 in FIG. 7 is carried out to update execution frequency data. As shown in the flow of FIG. 9, a check is first made to see if an execution frequency table 200 has been generated corresponding to the intermediate language module 300 selected in step 701. If such an execution frequency table 200 is not found, a new table 200 is generated and the execution count 202 is initialized to “1.” If the corresponding execution frequency table 200 is found to have been generated already, the execution count 202 is incremented by “1.” After that, the execution frequency tables 200 contained in the execution frequency data 126 are rearranged with their execution counts 202 used as the key into a binary search tree structure.

(1) With step 704 of FIG. 7 started, the intermediate language data interpretation program 123 selects the execution frequency table 200 pointed to by the pointer 303 in the intermediate language module 300 selected in step 701. A check is made to see if the execution frequency table 200 has already been generated (step 901).

(2) If the execution frequency table 200 in question is not found in step 901, the intermediate language data interpretation program 123 generates a new execution frequency table 200, copies to the module name field 201 the module name of the intermediate language module selected in step 701, and initializes the execution count 202 to “1.” If the execution frequency table 200 is found to have been generated already, the intermediate language data interpretation program 123 increments by “1” the execution count 202 of the execution frequency table 200 selected in step 701 (steps 902 and 903).

(3) The intermediate language data interpretation program 123 reconnects the pointers 203 and 204 of the execution frequency table 200 updated in step 902 or 903 in such a manner that the execution frequency tables 200 included in the execution frequency data 126 will make up a binary search tree structure with the execution counts 202 of the tables used as the key (step 904). The binary search tree is discussed in detail illustratively in “A New Dictionary of Algorithms in C” (a Japanese publication, Gijutsu-Hyoronsha).

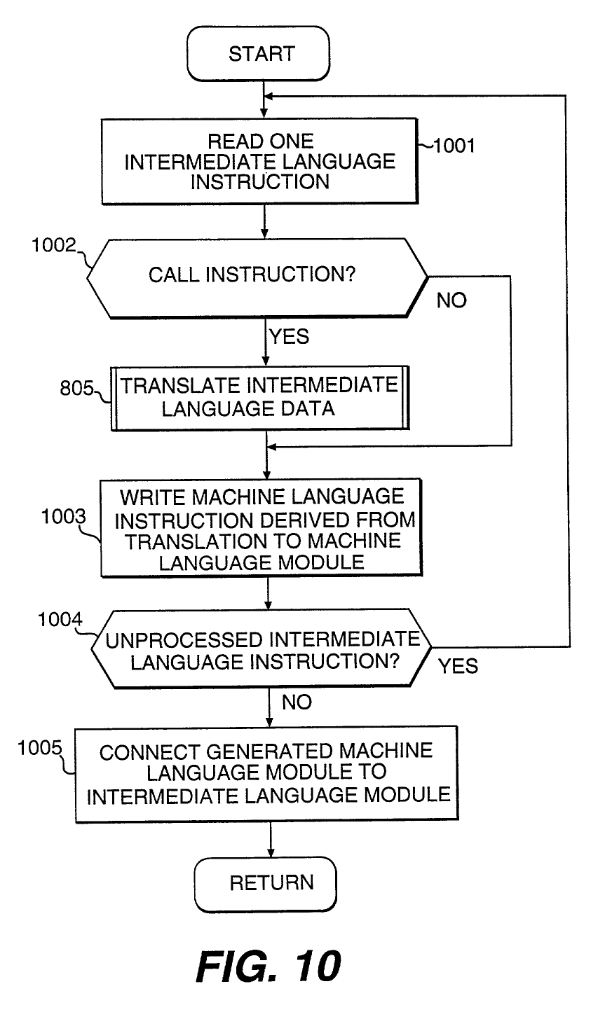

FIG. 10 is a flowchart detailing how step 805 is carried out to translate intermediate language data. The flow of FIG. 10 is a process which, in step 805 of FIG. 8, translates an intermediate language program into a machine language program. If there exists in an intermediate language module 300 a call instruction for calling another intermediate language module, the called intermediate language module 300 is first translated recursively into a machine language program. The machine language program thus generated is placed into the machine language module 400 pointed to by the pointer 303.

(1) With step 805 of FIG. 8 started, the object time translation program 124 reads one intermediate language instruction from the intermediate language program 304 in the intermediate language module 300 handed over as an argument, and checks to see if the intermediate language instruction thus read out is a call instruction for calling another module (steps 1001 and 1002).

(2) If the read-out intermediate language instruction is found in step 1002 to be a call instruction for calling another module, the object time translation program 124 calls recursively the intermediate language data translation step 805 using the called intermediate language module as an argument, and starts translating the intermediate language data in the intermediate language module in question (step 805).

(3) If, in step 1002, the read-out intermediate language instruction is not found to be a call instruction for calling another module, the object time translation program 124 translates into a machine language instruction the intermediate language instruction read out in step 1001, and writes the translated instruction to the machine language module 400 (step 1003).

(4) The object time translation program 124 then checks to see if there remains any intermediate language instruction yet to be processed within the intermediate language module 300 included in the intermediate language module 300 handed over as the argument in step 1001. If such an intermediate language instruction is detected, the object time translation program 124 returns to step 1001 and processes the next intermediate language instruction (step 1004).

(5) If no unprocessed intermediate language instruction is found in step 1004, the object time translation program 124 sets to the pointer 303 of the machine language module a pointer pointing to the machine language module 400 generated in step 1003 (step 1005).

FIG. 11 is a schematic view of a typical screen display in effect in step 806 for displaying the progress status of translation. In FIG. 11, reference numeral 1101 stands for a translation break button, and 1102 for a translation progress status meter. The translation break button 1101 provides a user interface through which a user instructs the input device 130 to stop object time translation. The translation progress status meter 1102 serves as a user interface presenting the user with a graphic indication of the progress status of object time translation.

The status display in FIG. 11 may be omitted optionally. Since the progress status of translation is to be displayed during execution of an intermediate language program, the display may be located in any available space on the display screen so as not to interfere with other indications such as the results of program processing. Illustratively, the progress status may be displayed transversely at the bottom of the screen or longitudinally in the left-hand or right-hand side margin of the screen.

While the present invention has been described above in connection with the preferred embodiments, one of ordinary skill in the art would be enabled by this disclosure to make various modifications to the embodiments and still be within the scope and spirit of the present invention as recited in the appended claims.

In the above-described embodiment, it is the intermediate language program that is translated into a machine language program. Alternatively, the invention may be applied to systems whereby a source program is translated into a machine language program.

According to the embodiment of the invention described above, the module currently having the highest execution frequency count is selected from the execution frequency data in parallel with the counting of how often each intermediate language module is executed. The modules thus selected are translated preferentially into machine language programs. This makes it possible for the hardware to efficiently execute the machine language programs of high execution frequencies derived from translation, whereby system performance is enhanced.

The above-described embodiment of the invention may have a predetermined threshold value by which to screen intermediate language modules in terms of execution frequencies before translation. The feature makes it possible to avoid translating unnecessary modules.

The embodiment described above records the total number of steps of a source program or an intermediate language program that has been read. Every time a program module has been translated into a machine language program, the total number of steps for the modules translated so far is divided by the total number of steps. The result of the division is displayed numerically on the screen, indicating the progress status of translation. The embodiment of the invention also permits translation into a machine language program to be stopped at any point during the translation, for example halfway through the translation.

As described and according to the invention, the modules of a source program or an intermediate language program are translated into machine language starting with those having the highest execution frequencies. This boosts the speed of the translation process.

According to the invention, the modules with execution frequencies lower than a predetermined threshold value are prevented from being translated. This shortens the time required for translation and reduces the necessary capacity of memory used for translation.

According to the invention, the progress status of translation may be displayed on the screen. This allows users to estimate the time required for the translation process, alleviating their psychological stress while they wait for the translation to terminate.

Also, according to the invention, the translation process may be stopped by users as desired. This allows the users to cut short the waiting time whenever they so desire.

What is claimed is:

1. An object time program translation system for interpreting either a source program or an intermediate language program common to a plurality of computers and for translating the program into a machine language program specific to any one of the computers, said object time program translation system comprising:
interpretation means for interpreting either said source program or said intermediate language program; and
program translation means for translating either said source program or said intermediate language program into a machine language program in units of modules;
wherein said interpretation means generates execution frequency data by counting the number of times each of the modules is executed while either said source program or said intermediate language program is being interpreted; and
wherein, concurrently with the interpretation of either said source program or said intermediate language program by said interpretation means, said program translation means selects from said execution frequency data the module that has been executed most frequently and translates the module in question into a machine language program.

2. The object time program translation system according to claim 1, wherein said program translation means does not translate into the machine language program the modules whose execution frequency data are below a predetermined threshold value.

3. The object time program translation system according to claim 1, further comprising translation progress status display means for displaying progress status of translation into the machine language program.

4. The object time program translation system according to claim 2, further comprising translation progress status display means for displaying progress status of translation into the machine language program.

5. The object time program translation system according to claim 1, wherein the translation into a machine language program may be stopped at any point prior to completion.

6. The object time program translation system according to claim 4, wherein the translation into a machine language program may be stopped at any point prior to completion.

7. A system for interpreting a high level language program for an individual computer of a plurality of computers comprising:
an interpreter for interpreting the high level language program having a plurality of modules; and
a translator for translating the high level language program into a lower level language program according to a given protocol;
wherein the protocol includes determining which modules of the high level language program are to be executed frequently and first translating such modules into the lower level language program.

8. The system according to claim 7, wherein the high level language program is a source program and the lower level language program is a machine language program.

9. The system according to claim 7, wherein the high level language program is an intermediate language program and the lower level language program is a machine language program.

10. The system according to claim 7, wherein the translator does not translate into the lower level language program the modules of the high level language program whose execution frequency data are below a predetermined threshold value.

11. The system according to claim 9, wherein the translator does not translate into the machine language program the modules of the intermediate level language program whose execution frequency data are below a predetermined threshold value.

12. The system according to claim 7, further comprising a translation progress status display which displays the progress status of translation into the lower level language program.

13. The system according to claim 9, further comprising a translation progress status display which displays progress status of translation into the machine language program.

14. The system according to claim 13, wherein the translation into the machine language program may be terminated at any point prior to completion.

15. A storage medium having stored thereon a program for performing the steps of:
interpreting a high level language program having a plurality of modules;
translating the high level language program into a lower level language program according to a give protocol; and
determining, according to the protocol, which specific modules of the high level language program are to be executed frequently and first translating only these specific modules into the lower level language.

16. The storage medium according to claim 15, wherein the program does not translate into the lower level language program the modules whose execution frequency data are below a predetermined threshold value.

17. The storage medium according to claim 15, wherein the program also performs the step of displaying the progress status of the translation into the lower level language program.

18. The storage medium according to claim 17, wherein the high level language program is an intermediate language program and the lower level language program is a machine language program.

19. A method of selectively translating a high level language program into a lower level language program comprising the steps of:
interpreting the high level language program, which contains a plurality of modules;
translating the high level language program into the lower level language program according to a give protocol; and
determining, according to the protocol, which specific modules of the high level language program are to be executed frequently and first translating only these specific modules into the lower level language.

20. The method according to claim 19, wherein the modules whose execution frequency data are below a predetermined threshold value are not translated into the lower level language.

21. The method according to claim 19, further comprising the step of displaying the progress status of the translation into the lower level language program.

22. The method according to claim 21, wherein the high level language program is an intermediate language program and the lower level language program is a machine language program.
